(19) United States
(12) Patent Application Publication
(10) Pub. No.: US 2025/0265950 A1
(43) Pub. Date: Aug. 21, 2025

(54) Smart Environmental Advertising System

(71) Applicant: Arsalan Peirofeiz, Woodland Hills, CA (US)

(72) Inventor: Arsalan Peirofeiz, Woodland Hills, CA (US)

(21) Appl. No.: 18/581,041

(22) Filed: Feb. 19, 2024

(51) Int. Cl. G09F 13/04

(52) U.S. Cl. CPC G09F 13/0472; G09F 13/0431

(57) ABSTRACT

For the purpose of advertising for persons, governments, a smart camera or motion sensor detector can be installed with or/alongside of the LED/LCD/Plasma/waterproof TV that is located/installed on the traffic light posts beam, or all can be installed on a separate post and beam that is located/installed parallel to the traffic light, where the load bearing of traffic light posts and beams are not strong enough to communicate with the water-proof TV. The motion sensor can detect motions of pedestrians, cars, motorcycles, bicycles and turn on the TV and show advertisement when there is passing by drivers and people passing by when the traffic light is red and turnoff when the light is green or there is no motion for 10 minutes/minutes and time can be adjusted, to save energy. The advertising of each Plasma/LED/LCD/out door TV can be managed and programmed from faraway or anywhere remotely via the internet and a modem.

### FIELD OF THE INVENTION

The invention relates to methods and apparatus of signage and advertising displays startable and stoppable in coordination with a traffic light.

### BACKGROUND OF THE INVENTION

Traffic lights have been around for a long time. Since the start of this century, traffic lights are sometimes an oddity but have mostly become a virtual necessity. Safety mandates the increasingly complex traffic signals interconnecting traffic lights electronically, to require each and every traffic light to coordinate vehicle and pedestrian traffic as well as properly coordinating just traffic at certain intersections, oftentimes synchronizing traffic lights along a stretch of commuter road to increase traffic flow.

Advertising displays are ubiquitous and promote merchants products and services in the form of billboards, or signage along the streets or perhaps store front displays. Because traffic lights are strategically located where a captive audience of travelers stuck at a red light are patiently waiting for the light to turn green, advertising at traffic signal locations is an excellent idea. Traffic lights are usually placed at locations of very high vehicular traffic, so advertising to those trapped in their cars either driving or riding, waiting for the red light to turn green is a great idea. Advertising revenues tied to traffic lights can benefit communities through road and street improvements or other necessary expenditures. Occupying drivers minds with advertising, while being just bored or frustrated of being stuck in traffic or just a very long red traffic light, might be a good idea.

Unfortunately, practical considerations and safety concerns have precluded the wide-spread or even general use proliferation of advertising connected to traffic signals in the past. Advertising displays could tend to distract the driver from the traffic light and from pedestrians and other drivers in the near vicinity when intersections are at their busiest and the driver's attention must be astute to prevent mishaps or accidents. Also the physical locations of many traffic lights adjacent, often over such, busy streets and walkways presents a problem in changing the advertising displays during normal business hours without impeding the flow of traffic.

It is an object of this invention, that a smart camera or motion sensor detector can be installed with or/alongside of the LED/LCD/Plasma/waterproof TV that is located/installed on the traffic light posts beam, or all can be installed on a separate post and beam that is located/installed parallel to the traffic light, where the load bearing of traffic light posts and beams are not strong enough, and the motion sensor can detect motions of pedestrians, cars, motorcycles, bicycles and turn on and show advertisement when there is passing by drivers and people passing by when the traffic light is red and turnoff when the light is green or there is no motion for 10 minutes/minutes and time can be adjusted, to save energy. The advertising of each Plasma/LED/LCD/out door TV can be managed and programmed from faraway or anywhere remotely via the internet and a modem. Speakers can be installed with this new smart advertising system to display adds with picture and sound. In the smart advertising system the picture and sound display can be in HD.

### SUMMARY OF THE INVENTION

A newly designed advertising method to promote and advertise for persons, companies, etc. to promote their new or existing commercial or educational or governmental ads that exist on social media, TV, news paper etc can be run on a Smart Environmental Advertising System which is using digital billboards or TV's (from small to large size TV's and billboards), that is designed for outside environment weather (rain and water proof), that will be connected, located and installed on the same street intersection traffic light beams (within 5 feet of the red, yellow, green light), In any direction, or within 10 feet of intersection light beam and post on a separate beam and post that is very close to and parallel to the traffic lights. Traffic lights are made of post and beam that is attached as one piece and the beam section holds the 3 lights, the red, green, yellow lights and when the red light turns on all cars must stop at the intersection and the installed smart digital billboard is connected to the traffic red light and ads will be displayed as soon as light turns red, so the drivers and passengers behind the traffic light can enjoy the show and see the commercial advertisings on the billboards installed on the traffic light beams near 3 red, green, yelow lights or installed on a separate post and beam near the 3 traffic lights while waiting for the red light to turn green. When the red traffic light turns green the billboard ads will stop playing the ads and will be turned off immediately, so the drivers can start driving and clearing the intersections. This new smart advertising method will make cities and countries more beautiful, especially at night, while advertising and marketing for companies, persons, government entities etc., Inventors, investors and their agents after patenting the Smart advertising system-method, will obtain all city and county permits before advertising in any city or county.

### BRIEF DESCRIPTIONS OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 Illustrates the post and beam of the traffic light with an advertising panel 20 attached to the beam 25, controlled by a motherboard 15, the motherboard is tied to the traffic light and the signal control box 5 with wires 10 wherein the advertising panel turns off when the light turns green.

FIG. 2 Illustrates the advertising panel 20 expanded, showing the back side of the advertising panel.

FIG. 3 Illustrates the back side of the advertising panel 20 located on the beam and the traffic light structure on the post with the requisite wires connecting the advertising panel 20 to the traffic light structure and also to the signal control box 5.

FIG. 4 Illustrates an expansive view of the front side of the advertising panel 20 located on the beam.

FIG. 5 Illustrates the pole and beam traffic/advertising panel light structure, with the advertising panel 20 attached along the beam, and the signal control box and the traffic light structure attached to the pole.

FIG. 6 illustrates a different view of the entire pole and beam structure where the front side of the advertising panel 20 is the only item located on the beam and the backside of the signal control box and the front side of the traffic light structure are located on the post.

FIG. 7 illustrates a different layout of the post 30 and beam 25 structures, where there are two post and beams in parallel, one above the other with the advertising panel 20 and a camera 35 is above the traffic light structure and wires are connecting the motherboard 15 of the advertising panel to the signal control box 5 and also to the camera.

FIG. 8 illustrates the interconnections within the advertising panel motherboard.

FIG. 9 illustrates two post and beam structures, one post and beam structure illustrates the backside of the advertising panel 20 the signal control box 5 and the traffic light structure and the other post and beam structure is empty.

FIG. 10 illustrates the two post and beam structures of FIG. 9, but this time the backside of the advertising panel 20 is located on the second post and beam while the backside of the traffic control box 5 and the traffic light structure is located on the first post and beam structure.

FIG. 11 illustrates the close up view of the advertising panel showing an overhanging cover 40 and two side panels to protect the advertising panel 20 from the elements.

FIG. 12 illustrates a top down view of the advertising panel and shows the overhanging cover 40 and the face of the advertising panel and how the advertising panel is connected to the beam of a post and beam structure.

FIG. 13 illustrates a side and enlarged view of the advertising panel attached to the beam of a post and beam structure. The overhanging cover 40 is shown as is the face of the advertising screen in addition to the backside of the advertising panel 20 which is hanging onto the beam and further supported by the metal bars lining the backside of the advertising panel. A wire is also shown coming from the advertising panel and downward.

FIG. 14 illustrates a side and enlarged view of just the advertising panel 20 located on the beam of the post and beam structure.

FIG. 15, illustrates the back side of FIG. 6, showing the air vents coming forth from the backside of the advertising panel 20 and also the metal rods that run down the backside of the advertising panel which bend at the bottom of said advertising panel and thereby attach the advertising panel to the beam of the post and beam structure securely.

FIG. 16 illustrates the bottom view of the advertising panel with the metal fittings 45 on the bottom of the advertising panel which facilitate attachment of the advertising panel to the beam of the post and beam structure.

FIG. 17 illustrates the side end view of the advertising panel, highlighting the metal fixtures on the backside of the advertising panel and how the metal rods 50 that run down the backside of the advertising panel bend up at an angle.

FIG. 18 illustrates the backside of the advertising panel looking straight on such that the 4 posts 55 sticking out of the back of the advertising panel can be plainly seen.

FIG. 19 illustrates a more straight shot of the backside of the advertising panel 20 located on the beam of the post and beam and the signal control box and the traffic light structure located on the post portion of that same post and beam structure, than does FIG. 15.

FIG. 20 illustrates the side view of the advertising panel 20.

FIG. 21 illustrates the front view of the advertising panel 20.

### DETAILED DESCRIPTION OF THE INVENTION

Reference will now be made in detail to embodiments of the invention, examples of which are illustrated in the accompanying drawing. Whenever possible, the same reference numbers will be used throughout the drawing to refer to the same of like parts.

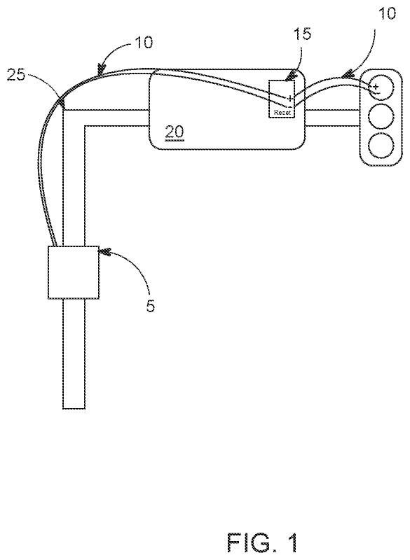

FIG. 1 illustrates the post and beam of a traffic light, with the advertising panel attached to the beam alongside the traffic light which is also attached to the beam. The signal control box is located on the post. There is a motherboard attached to the advertising panel which is tied, via wires shown, to the traffic light and the signal control box, thereby turning the advertising panel on, upon a red light signal from the signal control box. Upon the signal from the signal box that the light is changing to green, the advertising panel will be turned off. Although the wires are shown, wireless control between the signal control box and the advertising panel and between the advertising panel and the traffic light is possible.

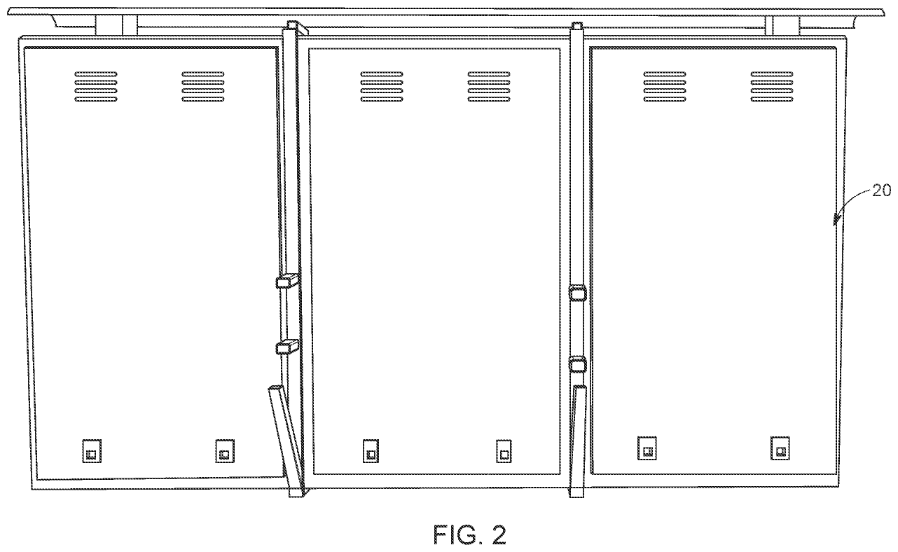

FIG. 2 illustrates the backside of the advertising panel, illustrating the mechanisms by which the advertising panel is attached to the beam.

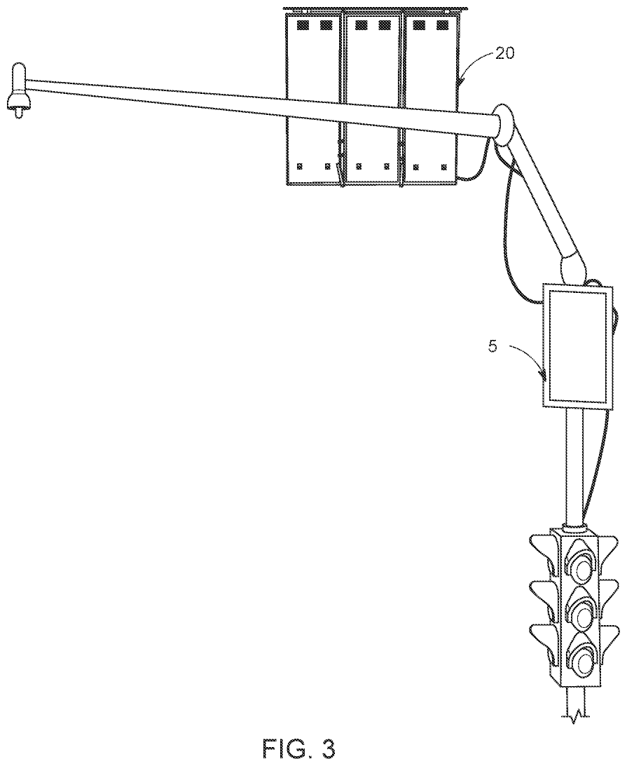

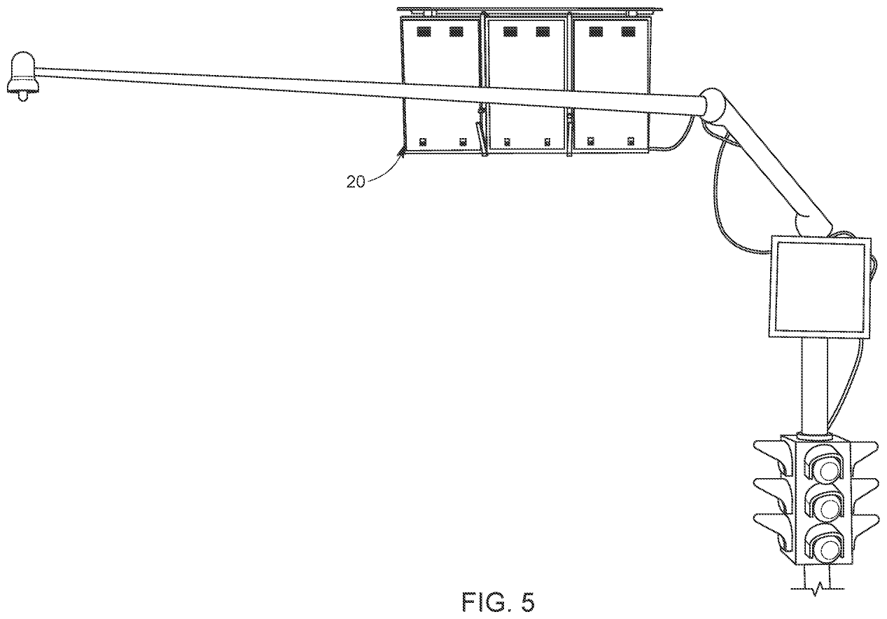

FIG. 3 illustrates the back side of the entire pole and beam traffic light structure, showing the back side of the advertising panel located attached to the beam, and the signal control box and the traffic light fixture located both on the pole, with the signal control box lying in between the traffic light fixture and the advertising panel. FIG. 3 is the backside of FIG. 5. Also illustrated in FIG. 3 are the wires connecting the advertising panel to the traffic light and the advertising panel to the signal control box. Although wire connections are shown, wirelessly connecting the advertising panel to the traffic light and the advertising panel to the signal control box is possible.

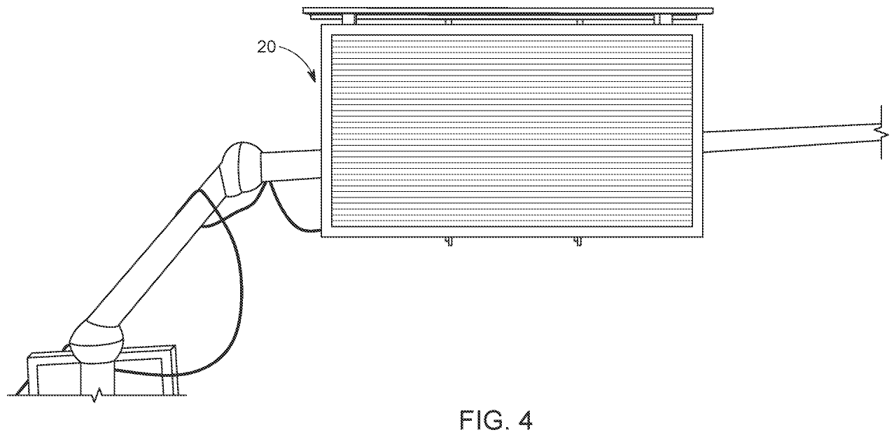

FIG. 4 illustrates the front of the advertising panel attached to the beam, magnified to see the panel clearly, also shown is a small portion of the signal control box. Although wires are shown connecting the signal control box to the advertising panel, such connections could be made wirelessly.

FIG. 5 Illustrates the entire post and beam structure with the backside of the advertising panel on the beam and the traffic light on the post and the signal control box also on the post in between the advertising panel and the traffic light. Although wires are shown connecting the advertising panel to the signal control box and also between the advertising panel and the traffic light, these connections could be made wirelessly.

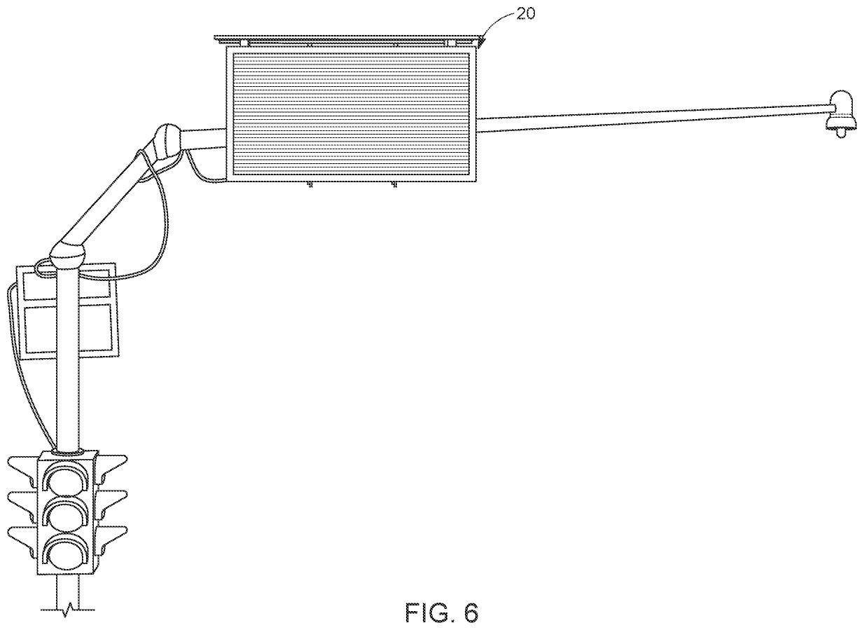

FIG. 6 illustrates a different view of the entire post and beam structure of FIG. 5 where the frontside of the advertising panel is shown located on the beam and the backside of the signal control box and the frontside of the traffic light structure are located on the post. The traffic light structure is showing red, so this is time during which the ads will be displayed on the advertising panel.

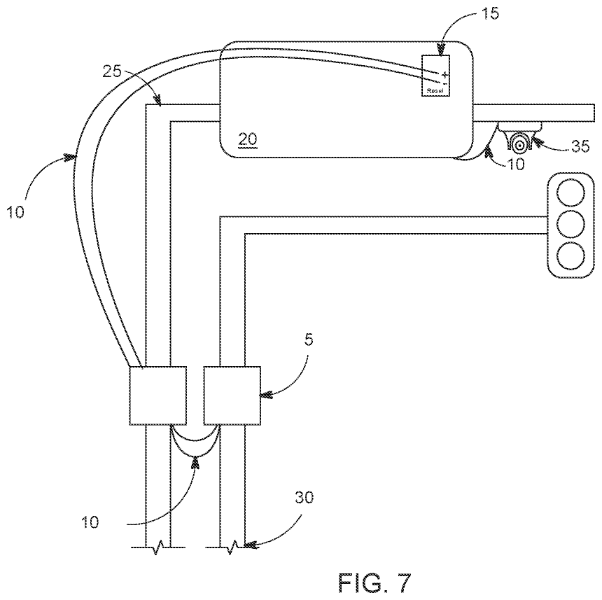

FIG. 7 illustrates a different post and beam structure where there are two post and beam structures separated by a few feet and in parallel with each other such that the advertising panel and camera are located above the traffic light structure on a separate post and beam structure. The advertising panel is electrically connected with wires shown to the signal control box such that when the signal control box turns the light red, the advertising panel can engage and light up with ads or promotions or government notifications, etc. Similarly, when the signal control box signals the advertising panel that it is turning green, the advertising panel immediately turns off. The advertising panel is also connected to the camera, the camera signaling to the advertising panel that people and/or dogs are in the cross walk thus signaling no play, while there are people crossing the street.

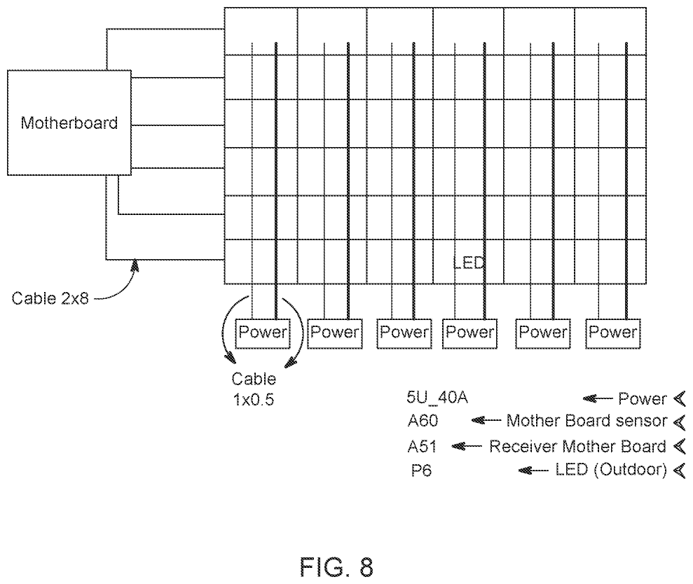

FIG. 8 illustrates the interconnections within the advertising motherboard.

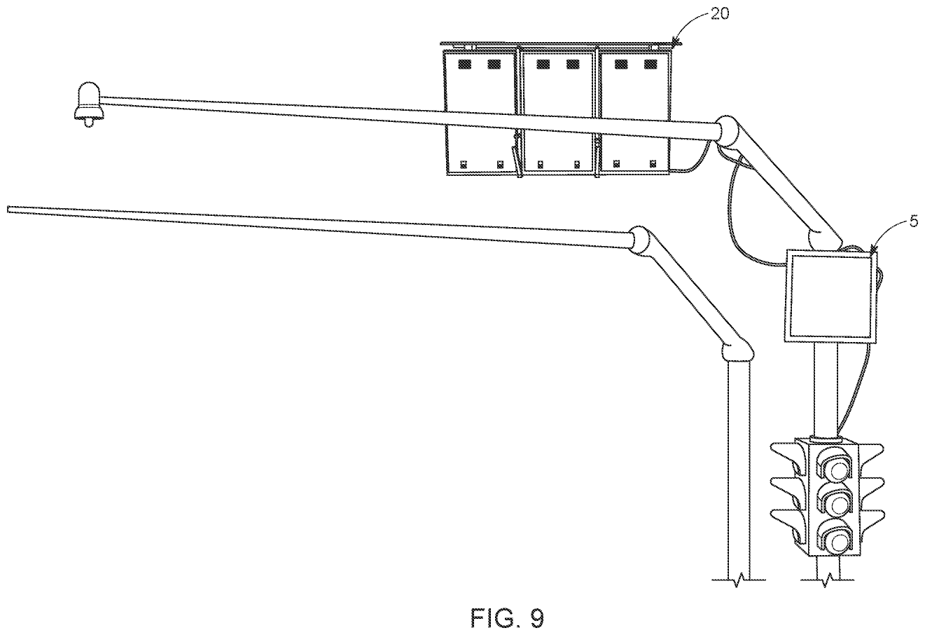

FIG. 9 illustrates two post and beam structures, one post and beam structure has the advertising panel the signal control box and the traffic light structure and the other post and beam structure is empty.

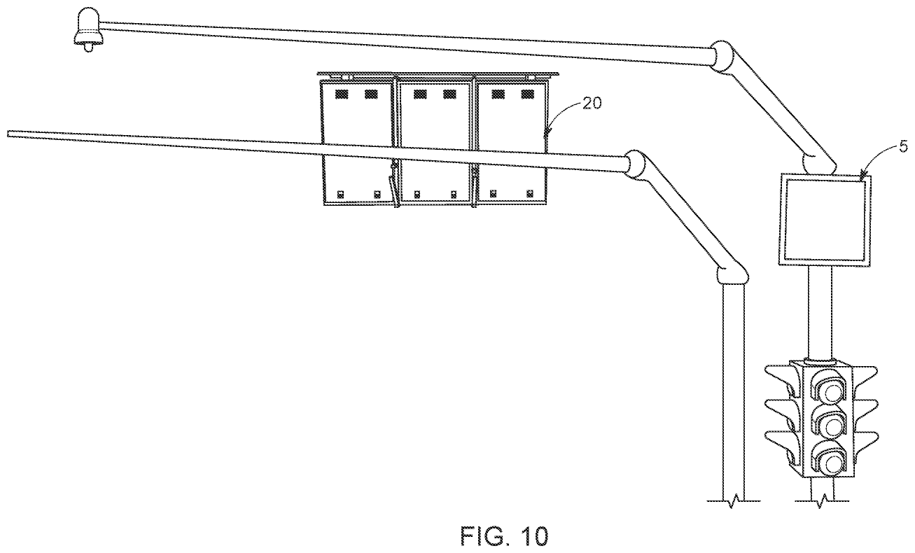

FIG. 10 illustrates the two post and beam structures of FIG. 9, but this time the backside of the advertising panel is located on the second post and beam while the backside of the traffic control box and the traffic light structure is located on the first post and beam structure.

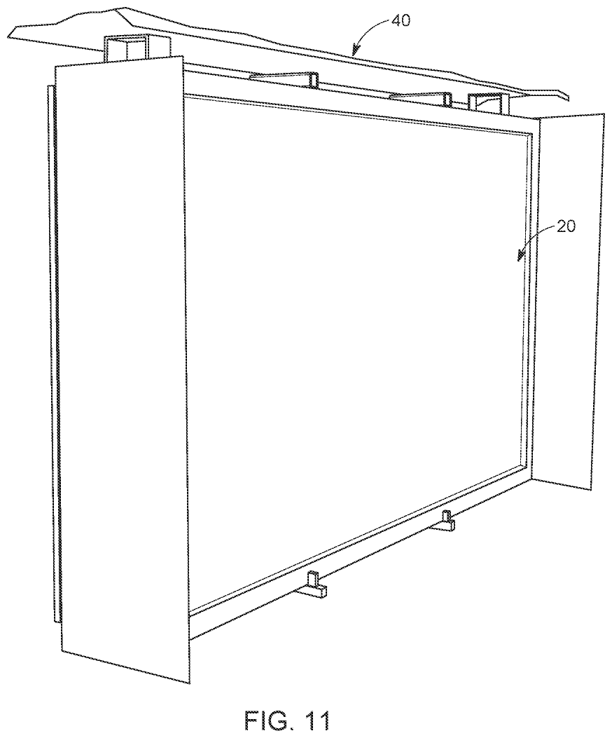

FIG. 11 illustrates the close up view of the advertising panel showing an overhanging cover and two side panels to protect the advertising panel from the elements where the overhanging cover shades the advertising panel screen and provides better visuals when the advertising panel is engaged with content. The side panels also block low sunshine from obliterating the scene on the advertising panel.

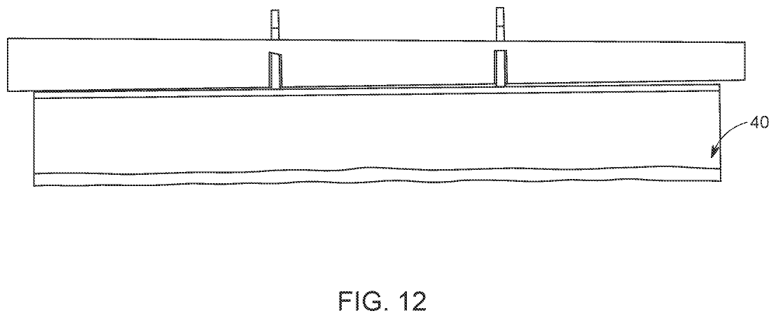

FIG. 12 illustrates a top down view of the advertising panel and shows the overhanging cover and the face of the advertising panel and how the advertising panel is connected to the beam of a post and beam structure. There are two support bars on the backside of the advertising panel which go below the advertising panel then bend up and through the beam of the post and beam thereby securing the advertising panel to the beam.

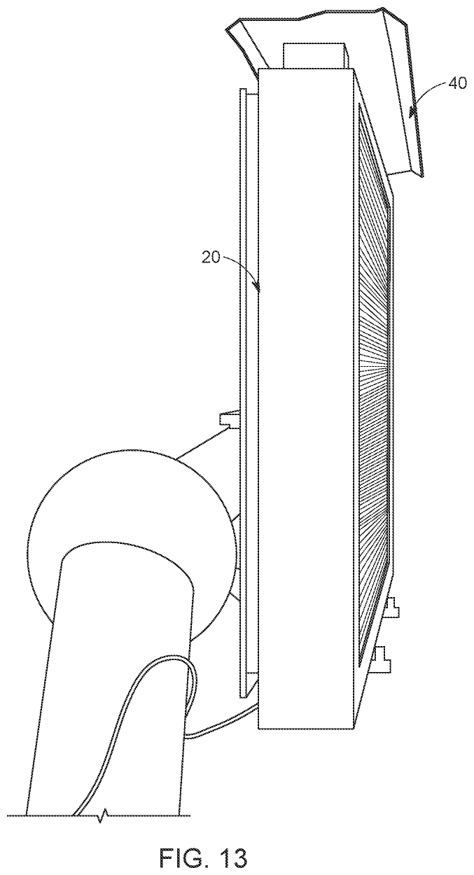

FIG. 13 illustrates a side and enlarged view of the advertising panel attached to the beam of a post and beam structure. The overhanging cover is shown as is the face of the advertising screen in addition to the backside of the advertising panel which is hanging onto the beam and further supported by the metal bars lining the backside of the advertising panel. A wire is also shown coming from the advertising panel and downward.

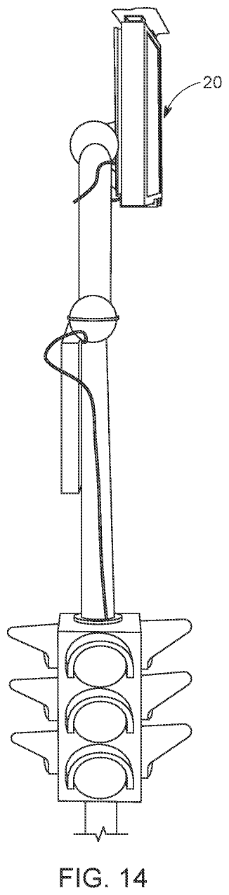

FIG. 14 is the view of FIG. 13, stepped back to see more of the side of the post and beam structure. FIG. 14 illustrates the entire side view of the post and beam structure such that only the post is visible. The side of the signal control box is shown as is the side of the advertising panel and the traffic light structure in addition to the wire which connects from the advertising panel to the signal control box to the traffic light structure, thereby connecting the traffic light to the advertising panel.

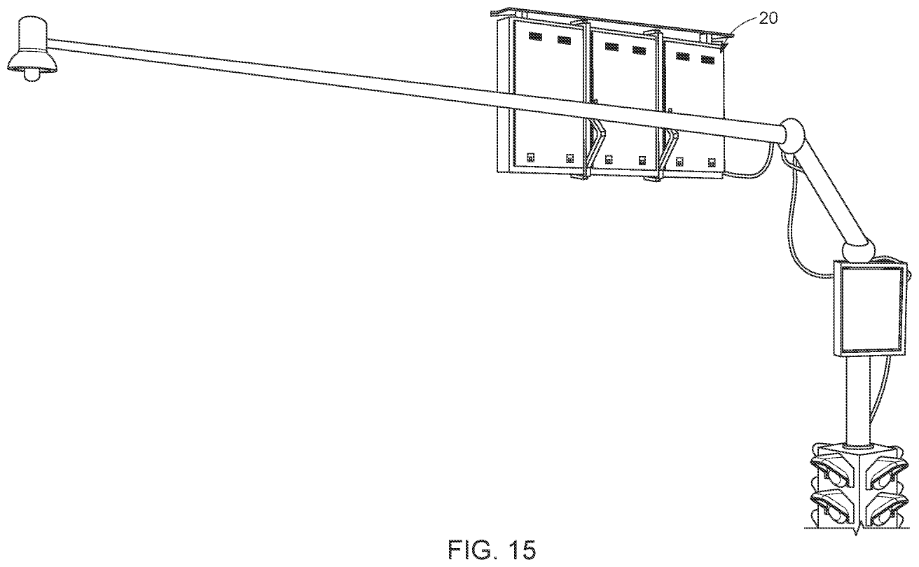

FIG. 15 illustrates the back side of FIG. 6, showing the air vents coming forth from the backside of the advertising panel and the metallic connections connecting the advertising panel to the beam of the post and beam structure.

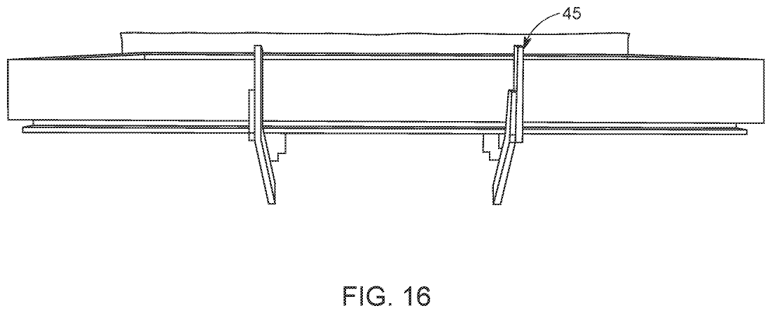

FIG. 16 illustrates the bottom view of the advertising panel with the metal fittings on the bottom of the advertising panel which facilitate attachment of the advertising panel to the beam of the post and beam structure.

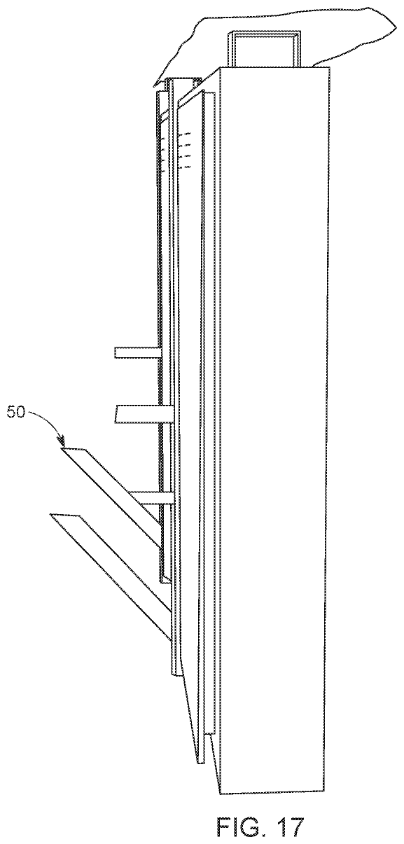

FIG. 17 illustrates the side end view of the advertising panel, highlighting the metal fixtures on the backside of the advertising panel and how the metal rods that run down the backside of the advertising panel bend up at an angle so as to facilitate attachment of the advertising panel to the beam of a post and beam.

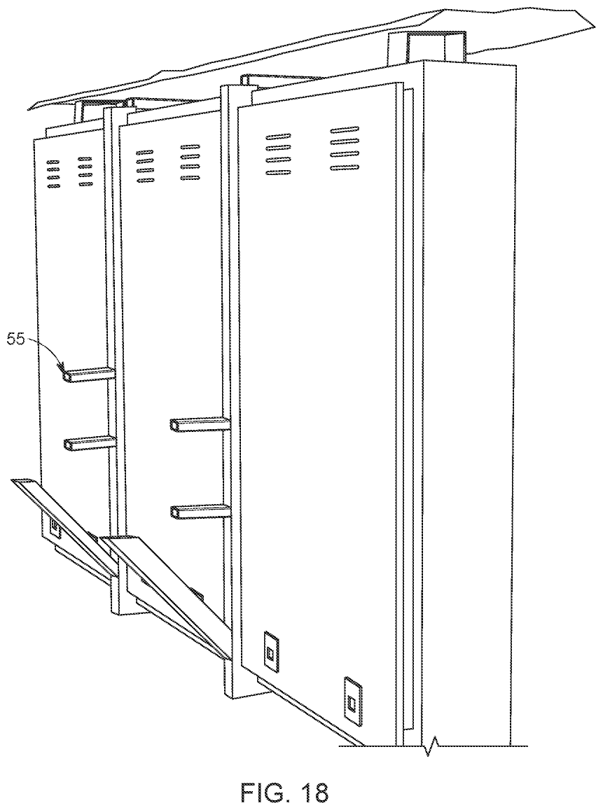

FIG. 18 illustrates the backside of the advertising panel looking straight on such that the 4 posts sticking out of the back of the advertising panel can be plainly seen. Although FIG. 17 displays the rods that run down the backside of the advertising panel, and then bend up at an angle, the 4 posts that stick out from the back are obscured, hence FIG. 18.

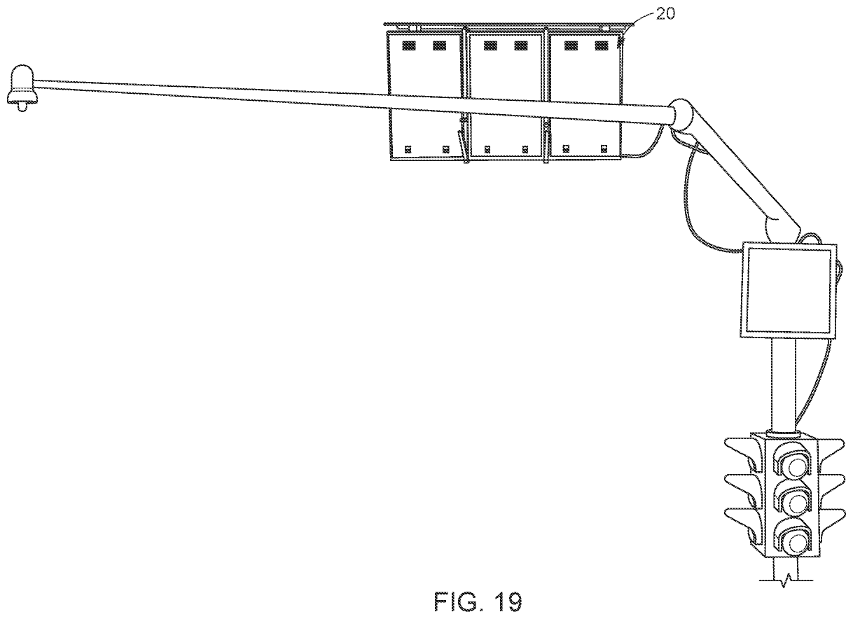

FIG. 19 illustrates a more straight shot of the backside of the advertising panel located on the beam of the post and beam and the signal control box and the traffic light structure located on the post portion of that same post and beam structure, than does FIG. 15.

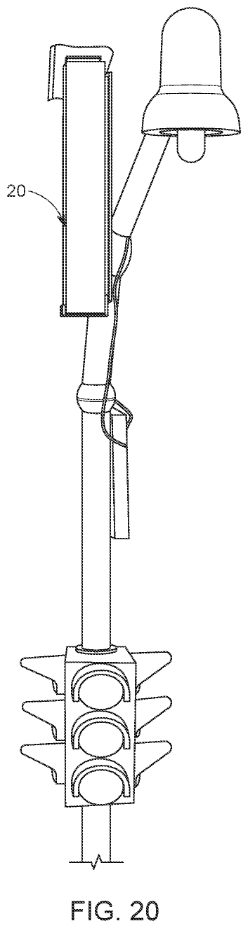

FIG. 20 illustrates the side end view of the advertising panel, the signal control box and the traffic light structure as if someone was across the street at the cross walk, this is the view that they would see when the advertising panel is located on the beam of the post and beam structure and the signal control box and the traffic light structure are both on the post of said post and beam structure.

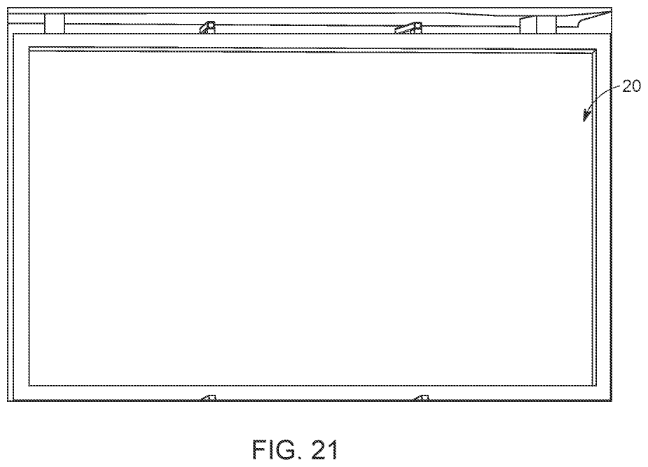

FIG. 21 illustrates the front view of just the advertising panel.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

I claim:

1. An method and apparatus for a screen located with a traffic light or within a very near proximity, to display advertising upon the traffic light turning red.

2. The method and apparatus of claim 1 wherein said within a very near proximity is within 10 feet from a traffic light beam.

3. The apparatus of claim 1 wherein when the screen is located with a traffic light, the screen is located on the same support structure that supports the traffic light.

4. The apparatus of claim 3, wherein said traffic light structure is a post and beam and when the post and beam is not strong enough to support said screen, said screen will be mounted on a post and beam parallel to said traffic post and beam.
